(19) United States
(12) Patent Application Publication
(10) Pub. No.: US 2017/0275505 A1
(43) Pub. Date: Sep. 28, 2017

(54) PRESSURE SENSITIVE ADHESIVES COMPRISING A POLYMODAL ASYMMETRIC MULTIARM ELASTOMERIC BLOCK COPOLYMER

(71) Applicant: 3M INNOVATIVE PROPERTIES COMPANY, St. Paul, MN (US)

(72) Inventors: Surojit Sinha, Bangalore (IN); Raja Krishnamurthy, Bangalore (IN); Joon Chatterjee, Bloomington, MN (US)

(73) Assignee: 3M INNOVATIVE PROPERTIES COMPANY, St. Paul, MN (US)

(21) Appl. No.: 15/529,629

(22) PCT Filed: Dec. 4, 2015
(86) PCT No.: PCT/US2015/063912

§ 371 Date: May 25, 2017

(30) Foreign Application Priority Data
Dec. 19, 2014 (IN) 6412/CHE/2014

(51) Int. Cl. C09J 7/02; C08F 297/04; C09J 153/02

(52) U.S. Cl. CPC C09J 7/0221; C09J 153/02; C08F 297/044; C09J 2409/00

(57) ABSTRACT

Pressure sensitive adhesives made from a polymodal asymmetric elastomeric block copolymer, a tackifying resin and liquid polyisoprene are provided. Articles containing these pressure sensitive adhesives including protective sheeting, labels, laminated adhesives, tapes and adhesive films are described. The pressure sensitive adhesive based on polymodal asymmetric block copolymer described herein exhibits good adhesion on various substrates such as stainless steel (SS), polypropylene (PP) and high density polyethylene (HDPE) and enhanced high temperature shear without the effect of electron beam or UV curing.

### CROSS REFERENCE TO RELATED APPLICATION

This application claims the benefit of Indian Patent Application Number 6412/CHE/2014, filed Dec. 19, 2014, the disclosure of which is incorporated by reference herein in its entirety.

### TECHNICAL FIELD

Pressure sensitive adhesives made from a polymodal asymmetric elastomeric block copolymer and articles containing these pressure sensitive adhesives including protective sheeting, labels, laminated adhesives, tapes and adhesive films are described.

### BACKGROUND

Block copolymers are known in the art for a variety of applications including the fabrication of impact resistant packaging materials, fabrication of molded articles and formulation of adhesives. Such block copolymers can be formulated in pressure sensitive adhesive compositions which may be used to make a variety of different articles including medical tapes, adhesive films and protective sheeting.

Articles made from pressure sensitive adhesives containing polymodal asymmetric elastomeric block copolymer often have good resistance to low stress peel, so that they resist lifting under light loads, maintain moderate adhesion, thereby easy to remove, and remove cleanly from a substrate without leaving adhesive residue. In addition, these articles withstand a variety of temperatures and chemical environments.

### SUMMARY

Pressure sensitive adhesives made from a polymodal asymmetric elastomeric block copolymer and articles containing these pressure sensitive adhesive are described.

In a first aspect, a pressure sensitive adhesive is provided. A pressure sensitive adhesive comprising: a) at least 30% by weight of a polymodal asymmetric multiarm elastomeric block copolymer; b) at least 25% by weight of a tackifying resin; and c) at least 0.1% by weight a liquid polyisoprene rubber.

In a second aspect, a trilayer adhesive system is provided. The trilayer adhesive system is represented by the formula: H-S-H, wherein the layers H and S are referred to as hard and soft layers respectively and wherein the hard layer is derived from a pressure sensitive adhesive comprising: at least 30% by weight of the polymodal asymmetric multiarm elastomeric block copolymer; at least 40% by weight of a tackifying resin; and at least 0.1% by weight of a liquid polyisoprene rubber and wherein the soft layer is derived from a pressure sensitive adhesive comprising: at least 48% by weight of the polymodal asymmetric multiarm elastomeric block copolymer; at least 25% by weight of a tackifying resin; and at least 15% by weight of a liquid polyisoprene rubber.

In a third aspect, an article containing a pressure sensitive adhesive is provided. The article comprises a backing sheet having first and second surfaces which is coated by a pressure sensitive adhesive on at least a portion of the first surface, wherein the pressure sensitive adhesive comprises: a) at least 30% by weight of a polymodal asymmetric multiarm elastomeric block copolymer; b) at least 25% by weight of a tackifying resin; and c) at least 0.1% by weight of a liquid polyisoprene rubber.

The above summary is not intended to describe each embodiment or every implementation of the invention. The Figures, Detailed description and Examples that follow more particularly exemplify these embodiments.

### BRIEF DESCRIPTION OF THE DRAWINGS

The invention may be more completely understood in consideration of the following detailed description of various embodiments in connection with the accompanying drawings, in which:

FIG. 1 shows the debonding graphs (Force (g) versus distance (mm)) of pressure sensitive adhesives based on polymodal asymmetric multiarm elastomeric copolymer (C5) and linear polymer (C6) respectively. Also shown are debonding graphs of pressure sensitive adhesives in the absence of liquid plasticizer based on polymodal asymmetric copolymer (C9) and linear polymer (C10) respectively.

FIG. 2 depicts the debonding graph of a trilayer adhesive system in comparison with the single layer adhesives.

FIG. 3 depicts 90° peel adhesion of a trilayer adhesive system on various surfaces (SS, PP, and HDPE).

### DETAILED DESCRIPTION

Pressure sensitive adhesives made from a polymodal asymmetric elastomeric block copolymer are provided. The pressure sensitive adhesives comprise a polymodal asymmetric multiarm elastomeric block copolymer; a tackifying resin; and a liquid polyisoprene. The adhesive in the present case is without any crosslinkers or crosslinking agents such as UV or electron beam radiation. The overall advantage is to provide pressure sensitive adhesive which exhibits excellent peel strength, high temperature shear properties and good adhesion on varied substrates in the absence of crosslinkers/crosslinking agents.

The pressure sensitive adhesive can adhere to varied substrates. For example, the adhesive can adhere to stainless steel, polypropylene, high density polyethylene substrates. Also provided are articles containing these pressure sensitive adhesive. Such articles include but not limited to protective sheeting, labels, laminated adhesives, tapes and adhesive films.

It must be noted that, as used in this specification and the appended claims, the singular forms “a,” “an” and “the” include plural referents unless the content clearly dictates otherwise.

Unless otherwise defined, all technical and scientific terms used herein have the same meaning as commonly understood by one of ordinary skill in the art.

The terms “comprising,” “including,” “having,” “containing,” “involving,” and the like are to be understood to be open-ended, i.e., to mean including but not limited to.

When the term “about” is used in describing a value or an endpoint of a range, the disclosure should be understood to include both the specific value and end-point referred to.

The term “pressure sensitive adhesive” as used herein refers to an adhesive which upon application of pressure results in an adhesion with the adherend. No solvent, water, or heat is required to bring about adhesion. As the name “pressure-sensitive” indicates, the degree of bonding is influenced by the amount of pressure applied.

The terms “polymodal” means that the copolymer comprises endblocks having at least two different molecular weights.

The term “asymmetric” means that the arms of the elastomeric block copolymer are not all identical since the molecular weights of the endblocks are not all the same. The block copolymer may also be referred to as having endblocks with mixed molecular weights. The block copolymer is further characterized as having at least one “high” and one “low” molecular weight endblock.

The term “tackifier” or “tackifying resin” as used herein refers to chemical compounds used in formulating adhesives to increase the tack, the stickiness of the surface of the adhesive. They are usually low-molecular weight compounds with high glass transition temperature. At low strain rate, they provide higher stress compliance, and become stiffer at higher strain rates.

The polymodal asymmetric elastomeric block copolymer comprises a polymerized monovinyl aromatic compound and a conjugated diene. The block copolymer has the general formula QₙY where Q represents an arm of the block copolymer and has the formula S-B; n represents the number of arms (Q) and is at least 3; and Y is the residue of a multifunctional coupling agent.

Furthermore, S is a nonelastomeric polymer segment endblock of a polymerized monovinyl aromatic homopolymer, there being at least two different molecular weight endblocks in the block copolymer. The number of molecular weights may be altered to tailor the block copolymer for use in specific applications. The molecular weight distribution of the endblock polymer is bimodal, that is, comprises two different molecular weight ranges, a high range and a low range. The number average molecular weight of the higher molecular weight endblock (Mn)_{H} is at least 5,000, or at least 10,000. The number average molecular weight of the higher molecular weight endblock (Mn)_{H} is up to 50,000 or up to 35,000. The number average molecular weight of the lower molecular weight endblock (Mn)_{L} is at least 1,000, at least 2,000, or at least 4,000. The number average molecular weight of the lower molecular weight endblock (Mn)_{L} is up 10,000 up to 9,000 or up to 7,000.

The ratio of arms having high molecular weight endblocks to arms having low molecular weight endblocks has an effect on a number of properties, including the tensile strength of the polymer. When the block copolymer has only two different molecular weight endblock distributions, the number of arms containing higher molecular weight endblocks is at least 5%, at least 10% or at least 15% of the total number of arms in the block copolymer. In some embodiments, the number of arms containing higher molecular weight endblocks is up to 70%, up to 45% or up to 35% of the total number of arms in the block copolymer.

In addition, B is an elastomeric polymer segment midblock which connects each arm Q to the residue of a multifunctional coupling agent (Y) and comprises a polymerized conjugated diene or combination of conjugated dienes.

The midblocks may contain small amounts of a monovinyl aromatic material, but in the preferred case, are predominantly polymerized conjugated diene or mixtures of conjugated dienes. The block copolymer in some embodiments comprises at least 4%, at least 5% or at least 6% by weight of a polymerized monovinyl aromatic homopolymer. In certain other embodiments, the block copolymer comprises up to 40%, up to 25% or up to 15% by weight of a polymerized monovinyl aromatic homopolymer. The block copolymer comprises at least 60%, at least 75% or at least 85% by weight of a polymerized conjugated diene or polymerized combination of dienes. In further embodiments, the block copolymer comprises up to 96%, up to 95% or up to 94% by weight of a polymerized conjugated diene. The nonelastomeric endblock polymer segments and the elastomeric midblock polymer segments are generally present as at least two distinct phases. The endblocks from the lowest molecular weight distribution may be present as a third phase depending on the difference in endblock molecular weights.

The monomers which comprise the polymerized monovinyl aromatic endblocks S typically contain from 8 to 18 carbon atoms, and examples of useful monovinyl aromatic monomers include styrene, alpha-methylstyrene, vinyltoluene, vinylpyridine, ethylstyrene, t-butylstyrene, isopropylstyrene, dimethylstyrene, other alkylated styrenes, and the like. In some embodiments, the polymerized monovinyl aromatic compound is polystyrene. The monomers which comprise the polymerized conjugated diene midblocks typically contain from 4 to 12 carbon atoms, and examples of useful conjugated diene monomers include but not limited to butadiene, isoprene, ethylbutadiene, phenylbutadiene, piperylene, dimethylbutadiene, hexadiene, ethylhexadiene, and the like. The polymerized conjugated dienes may be employed individually or as mixtures or copolymers with one another. In some embodiments, the polymerized conjugated diene is selected from the group consisting of polybutadiene, polyisoprene, and mixtures thereof.

The multifunctional coupling agents ‘Y’ suitable for the invention may be any of the polyalkenyl coupling agents or other materials known to have functional groups which can react with carbanions of the living polymer to form linked polymers. Examples of suitable multifunctional coupling agents include silicon halides, polyepoxides, polyisocyanates, polyketones, polyanhydrides, dicarboxylic acid esters. Suitable polyalkenyl coupling agents may be aliphatic, aromatic or heterocyclic. Examples of aliphatic polyalkenyl coupling agents include the polyvinyl and polyalkyl acetylenes, diacetylenes, phosphates and phosphites, dimethacrylates such as ethylene dimethacrylate, and the like. Examples of suitable heterocyclic polyalkenyl coupling agents include divinyl pyridine, divinyl thiophene, and the like. Examples of suitable aromatic alkenyl coupling agents, include polyvinyl benzene, polyvinyl toluene, polyvinyl xylene, polyvinyl anthracene, polyvinyl naphthalene, divinyl durene and the like. Suitable polyvinyl groups include divinyl, trivinyl and tetravinyl. In an embodiment the multifunctional coupling agent is selected from the group consisting of o-divinylbenzene, m-divinylbenzene, p-divinylbenzene, and mixtures thereof.

The polymodal asymmetric elastomeric block copolymer may be prepared by conventional block copolymer anionic polymerization technology. In some embodiments, the elastomeric block copolymer may be prepared in accordance to the procedure outlined in U.S. Pat. No. 5,296,547 (Nestegard et al.) and U.S. Pat. No. 5,393,787 (Nestegard et al.). In certain embodiments, the pressure sensitive adhesive of the present disclosure comprises at least 30%, at least 35% or at least 40% by weight of the polymodal asymmetric multiarm elastomeric block copolymer. In further embodiments, the pressure sensitive adhesive of the present disclosure comprises up to 60%, up to 58%, or up to 53% by weight of the polymodal asymmetric multiarm elastomeric block copolymer.

Tackifiers or tackifying resins generally refer to materials which are miscible with the elastomeric block in the block copolymer, have a number average molecular weight Mₙ of 10,000 grams per mol (g/mol) or less, a softening point above 70° C. as determined using a ring and ball apparatus, and a glass transition temperature (T_{g}) of −30° C. or more as measured by differential scanning calorimetry (DSC). The tackifying resins that are compatible with the elastomeric polymer segment midblock are generally preferred in providing a pressure sensitive adhesive. In some embodiments, the tackifying resin is further compatible with at least one non elastomeric polymer segment endblock. Suitable tackifying resins may include rosin and rosin derivatives, polyterpenes, coumarone indenes, hydrogenated resins and hydrocarbon resins, for example: alpha pinene-based resins, beta pinene-based resins, limonene-based resins, piperylene-based hydrocarbon resins, esters of rosins, polyterpene and aromatic modified polyterpene resins, aromatic modified piperylene-based hydrocarbon resins, aromatic modified dicyclopentadiene-based hydrocarbon resins and aromatic modified co-terpene and ter-terpene resins. In certain embodiments, tackifying resins are hydrogenated hydrocarbon resin that will impart low colour as well as could be of preferential solubility with mid-block elastomer phase of block copolymer.

The tackifying resin may be present in the pressure sensitive adhesive in an amount of at least 25%, at least 30% or at least 35% by weight of the pressure sensitive adhesive. In other embodiments, the tackifying resin is present in an amount of up to 60%, up to 55% or up to 50% by weight of the pressure sensitive adhesive.

Plasticizers are employed in the adhesive formulation to provide wetting action and/or viscosity control. In the present case, liquid polyisoprene rubber is used which has a molecular weight of up to 20,000 grams/mole and has a glass transition temperature (T_{g}) of −63° C. In some embodiments, the liquid polyisoprene rubber may be present in the pressure sensitive adhesive in an amount of at least 0.1%, at least 5% or at least 10% by weight of the pressure sensitive adhesive. In other embodiments, the liquid polyisoprene rubber may be present in an amount of up to 30%, up to 25% or up to 20% by weight of the pressure sensitive adhesive.

In an embodiment, the pressure sensitive adhesive of the present disclosure comprises at least 30% by weight of the polymodal asymmetric multiarm elastomeric block copolymer, at least 25% by weight of a tackifying resin, and at least 0.1% by weight a liquid polyisoprene rubber. In certain other embodiments, the adhesive may comprise up to 60% by weight of the polymodal asymmetric multiarm elastomeric block copolymer, up to 60% by weight of a tackifying resin and up to 30% by weight of a liquid polyisoprene rubber. In a further embodiment, the pressure sensitive adhesive comprises: a) at least 40% by weight of the polymodal asymmetric multiarm elastomeric block copolymer, b) at least 35% by weight of a tackifying resin, and c) at least 10% by weight a liquid polyisoprene rubber.

The pressure sensitive adhesive of the present disclosure may optionally include solvent and fillers. Examples of suitable solvents include, but are not limited to ethyl acetate, tetrahydrofuran, toluene and methylethyl ketone. Fillers typically can alter the storage modulus of the pressure sensitive adhesive. Other optional additives include but not limited to pigments, UV stabilizers, antioxidants, and the like. These optional ingredients may be present in an amount as needed.

A multilayer adhesive system made from pressure sensitive adhesive is provided. The multilayer adhesive system may be either a (-H-H-H-), (-S-S-S-) or (-H-S-H-) type or combinations thereof. In certain embodiments, the multilayer system is of a by -H-S-H- type wherein ‘H’ and ‘S’ herein are referred to as hard and soft layers respectively. In certain embodiments the multilayer system represented by the formula: H-S-H is provided. These layers are composed of pressure sensitive adhesive which differ in their chemical composition. The soft layer contains relatively higher amount of the liquid polyisoprene rubber than the hard layer. The hard layer is derived from a pressure sensitive adhesive comprising at least 30% by weight of the polymodal asymmetric multiarm elastomeric block copolymer, at least 40% by weight of a tackifying resin, and at least 0.1% by weight a liquid polyisoprene rubber. In other embodiments, the hard layer of the trilayer adhesive system is made from a pressure sensitive adhesive which may comprise up to 45% by weight of the polymodal asymmetric multiarm elastomeric block copolymer, up to 60% by weight of a tackifying resin and up to 5% by weight of a liquid polyisoprene rubber. The soft layer is derived from a pressure sensitive adhesive composition comprising: a) at least 48% by weight of a polymodal asymmetric multiarm elastomeric block copolymer; b) at least 25% by weight of a tackifying resin; c) at least 15% by weight of a liquid polyisoprene rubber. In certain embodiments, the soft layer of the trilayer adhesive system is derived from a pressure sensitive adhesive composition comprising a) up to 55% by weight of a polymodal asymmetric multiarm elastomeric block copolymer; b) up to 35% by weight of a tackifying resin and c) up to 30% by weight of a liquid polyisoprene rubber.

The multilayer adhesive system is constructed by laminating the individual layers comprising the pressure sensitive adhesive and pressed together such that a middle layer is sandwiched on either side by the outer moieties to form the multilayer. Each of the multilayer adhesive layers is usually kept at room temperature near approximately 25° C. with 50% relative humidity for approximately 24 hours before they are tested further. In certain embodiments, the multilayer adhesive system may be a trilayer or a tetralayer system.

Articles are provided that contain pressure sensitive adhesive. In an embodiment, an article comprising a backing sheet having first and second surfaces is coated by a pressure sensitive adhesive on at least a portion of the first surface, wherein the pressure sensitive adhesive comprises: a) at least 30% by weight of the polymodal asymmetric multiarm elastomeric block copolymer, b) at least 25% by weight of a tackifying resin, and c) at least 0.1% by weight a liquid polyisoprene rubber.

The adhesive composition which is the same as that described above may be applied to a substrate from a solution of up to about 40% by weight solids of the ingredients in a solvent such as toluene, the solvent being removed by evaporation. In some embodiments, adhesives may also be applied to a substrate as a 100% solids hot melt.

Any substrate can be used. Some suitable substrates include paper, fabric, glass, ceramic material, polymeric material, metal-containing materials such as metals or metal oxides or combinations thereof. In some embodiments, the substrate may be polypropylene, high density polyethylene or stainless steel substrate.

Articles that are coated include protective sheeting, labels, laminated adhesives, tapes and adhesive films which employ the pressure sensitive adhesive. In certain embodiments, the tape comprises a backing having first and second surfaces and a pressure sensitive adhesive coated on at least a portion of the first major surface. The backing sheet may be a plastic film, paper or any other suitable material, and the tape may include various other layers or coatings, such as primers, release coatings and the like, which are generally known and used in the manufacture of pressure sensitive adhesive tapes. The tape may be coated onto both sides of the backing to form a double sided tape, or the adhesive may be coated onto a backing having a release surface so that the adhesive film may be utilized as a transfer tape.

### EXEMPLARY EMBODIMENTS

Embodiment A is a pressure sensitive adhesive comprising: a) at least 30% by weight of a polymodal asymmetric multiarm elastomeric block copolymer, b) at least 25% by weight of a tackifying resin, and c) at least 0.1% by weight of a liquid polyisoprene rubber.

Embodiment B is a pressure sensitive adhesive of Embodiment A wherein the adhesive comprises at least 35% by weight of the polymodal asymmetric multiarm elastomeric block copolymer.

Embodiment C is a pressure sensitive adhesive of Embodiment A wherein the adhesive comprises at least 30% by weight of a tackifying resin.

Embodiment D is a pressure sensitive adhesive of Embodiment A wherein the adhesive comprises at least 5% by weight of a liquid polyisoprene rubber.

Embodiment E is a pressure sensitive adhesive of any one of Embodiment A to D wherein the adhesive comprises: a) at least 40% by weight of the polymodal asymmetric multiarm elastomeric block copolymer, b) at least 35% by weight of a tackifying resin, and c) at least 10% by weight of a liquid polyisoprene rubber.

Embodiment F is a pressure sensitive adhesive of Embodiment A wherein said polymodal asymmetric multiarm elastomeric block copolymer comprises a polymerized monovinyl aromatic compound and a conjugated diene and has the formula QₙY and wherein: Q represents an individual arm of the block copolymer and has the formula S-B; n represents the number of arms Q in the block copolymer and is a whole number of at least 3; and Y is the residue of a multifunctional coupling agent; and further wherein: (a) S is a nonelastomeric polymer segment endblock of a polymerized monovinyl aromatic homopolymer, there being at least two different molecular weight endblocks in the copolymer, a higher molecular weight endblock and a lower molecular weight endblock, wherein: (i) the number average molecular weight (Mn) of the higher molecular weight endblock H ((Mn)H) is at least 5,000 grams/mole; (ii) the number average molecular weight (Mn) of the lower molecular weight endblock L ((Mn)L) is at least 1,000 grams/mole; and (b) B is an elastomeric polymer segment midblock which connects each arm to the residue of a multifunctional coupling agent (Y) and comprises a polymerized conjugated diene or combination of conjugated dienes and wherein the polymerized monovinyl aromatic compound is present in an amount of at least 4% by weight of the total weight of the block copolymer and the polymerized conjugated diene is present in an amount of at least 60% by weight of the total weight of the block copolymer.

Embodiment G a pressure sensitive adhesive of Embodiment F wherein the polymerized monovinyl aromatic compound is present in an amount of at least 6% by weight of the total weight of the block copolymer.

Embodiment H is a pressure sensitive adhesive of Embodiment G wherein the polymerized monovinyl aromatic compound is polystyrene.

Embodiment I is a pressure sensitive adhesive of Embodiment F wherein the polymerized conjugated diene is selected from the group consisting of polybutadiene, polyisoprene, and mixtures thereof.

Embodiment J is a pressure sensitive adhesive of Embodiment F wherein the multifunctional coupling agent is selected from the group consisting of o-divinylbenzene, m-divinylbenzene, p-divinylbenzene, and mixtures thereof.

Embodiment K is a pressure sensitive adhesive of Embodiment A wherein (Mn)H is at least 10,000 grams/mole and (Mn)L is at least 4,000 grams/mole.

Embodiment L is a pressure sensitive adhesive of Embodiment F wherein the number of arms containing higher molecular weight endblocks is at least 10% of the total arms in the block copolymer.

Embodiment M is a pressure sensitive adhesive of Embodiment F wherein the number of arms containing higher molecular weight endblocks is at least 15% of the total arms in the block copolymer.

Embodiment N is a pressure sensitive adhesive of Embodiment A wherein the tackifying resin is compatible with the elastomeric polymer segment midblock.

Embodiment O is a pressure sensitive adhesive of Embodiment A or N wherein the tackifying resin is further compatible with at least one nonelastomeric polymer segment endblock.

Embodiment P is a pressure sensitive adhesive of Embodiment A wherein the tackifier resin is selected from rosin and rosin derivatives, polyterpenes, coumarone indenes, hydrogenated resins and hydrocarbon resins.

Embodiment Q is a pressure sensitive adhesive of Embodiment P wherein the tackifier resin is a hydrocarbon resin selected from alpha pinene-based resins, beta pinene-based resins, limonene-based resins, piperylene-based hydrocarbon resins, esters of rosins, polyterpene and aromatic modified polyterpene resins, aromatic modified piperylene-based hydrocarbon resins, aromatic modified dicyclopentadiene-based hydrocarbon resins and aromatic modified co-terpene and ter-terpene resins.

Embodiment R is a pressure sensitive adhesive of Embodiment Q wherein the tackifying resin is a hydrogenated hydrocarbon resin.

Embodiment S is a pressure sensitive adhesive of Embodiment A wherein the adhesive does not contain any cross linker.

Embodiment T is a multilayer adhesive system represented by the formula: -H-S-H-; wherein the layers H and S are referred to as hard and soft layers respectively and wherein the hard layer is derived from a pressure sensitive adhesive comprising: a) at least 30% by weight of a polymodal asymmetric multiarm elastomeric block copolymer; b) at least 40% by weight of a tackifying resin; and c) at least 0.1% by weight of a liquid polyisoprene rubber and wherein the soft layer is derived from a pressure sensitive adhesive composition comprising: a) at least 48% by weight of a polymodal asymmetric multiarm elastomeric block copolymer; b) at least 25% by weight of a tackifying resin; and c) at least 15% by weight of a liquid polyisoprene rubber.

Embodiment U is an article comprising a backing sheet having first and second surfaces which is coated by a pressure sensitive adhesive on at least a portion of the first surface, wherein the pressure sensitive adhesive comprises: a) at least 30% by weight of a polymodal asymmetric multiarm elastomeric block copolymer, b) at least 25% by weight of a tackifying resin, and c) at least 0.1% by weight of a liquid polyisoprene rubber.

Embodiment V is an article of Embodiment U wherein the backing sheet is a plastic film or paper.

### EXAMPLES

These examples are merely for illustrative purposes and are not meant to be limiting on the scope of the appended claims. All parts, percentages, ratios, and the like in the examples and the rest of the specification are by weight, unless noted otherwise.

The identity of the specific constituents of the pressure sensitive adhesive of the present disclosure is listed in Table-1.

TABLE 1

| Material | Description | Manufacturer |
|---|---|---|
| “KD1340” | Polymodal asymmetric block | Prepared according to the |
| | copolymer which has a total molecular | protocol outlined in U.S. |
| | weight of 1,100,000 g/mol and | Pat. No. 5,296,547 and |
| | comprising PS block of 5000 and | U.S. Pat. No. 5,393,787. |
| | 20,000 g/mol and PI arms of 135000 | |
| | g/mol. | |
| Regalite R1125 | Tackifying resin which is an | Eastman |
| | aromatically modified petroleum | |
| | hydrocarbon resin having a glass | |
| | transition temperature (T_{g}) of 70.11° C. | |
| LIR-30 | Liquid polyisoprene, which has a glass | Kuraray Inc. |
| | transition temperature (T_{g}) of −63° C. | |
| ‘D1161’ (represented | Linear block copolymer which is a SIS | Kraton Inc. |
| hereinafter as “KD 1161”) | copolymer which is having PS content | |
| | of 15%. | |

### Test Methods

### 180° Peel Adhesion and Static Shear

To measure adhesion, the tapes were conditioned in the controlled environment for 24 hours and analyzed on an IMASS Peel tester system for material testing, according to standard tape method PSTC-1, Peel Adhesion for Single Coated Tapes 180° Angle. The tape was removed at an angle of 180 degrees at a rate of 30.5 cm/min (12 in/min). A load cell linked to a computer was used to estimate the value reported for adhesion. The overlap area of adhesive for shear was 1 square inch and peel adhesion was measured with tape of 1 inch width.

### Tack Test

Tack tests of the pressure sensitive adhesive compositions were performed with TA XT plus Texture Analyzer equipment with PP probe having 6 mm diameter with PSA sheet of different compositions with Probe diameter/thickness of PSA film <50 (nearly).

The following parameters were set in equipment for probe tack test.

| Pre test speed | 0.5 | mm/sec |
|---|---|---|
| Test speed | 0.01 | mm/sec |
| Post test speed | 0.05 | mm/sec |
| Applied force | 2000 | gm |
| Return distance | 20 | mm |
| Contact time | 60 | sec |
| Trigger type | Auto | |
| Trigger force | 5 | gm |

### Example-1

Pressure sensitive adhesives were prepared by combining the polymodal asymmetric block copolymer with hydrogenated hydrocarbon, which is a tackifying resin, and liquid isoprene rubber, in the amounts given in Table 2. The amounts are given as weight percentage (wt %). The resulting compositions were weighed dry and dissolved in toluene to give 40% solids by weight solution. The solutions were separately knife coated onto 2Mil PET thick biaxially oriented polyethylene terephthalate (PET) film at a coating weight of 50±2 gsm. The coatings were dried for three minutes at room temperature (22° C.) followed by 10 minutes at 90° C. in a convection oven and removed from the oven and covered with a silicone coated release liner.

Other adhesive compositions were also prepared in a similar manner except that linear block copolymer (KD1161) was used instead of the asymmetric polymodal (KD1340) for the purpose of comparison referred as “C6 (COMP)”. In addition a few other adhesive compositions with either a tackifying resin or liquid polyisoprene being present (referred to as “C9 (COMP)”, “C10 (COMP)”, “C11 (COMP)” and “C12 (COMP)” with asymmetric polymodal block copolymer and linear block copolymer respectively were also prepared to illustrate the advantageous effect of the pressure sensitive adhesive containing the asymmetric block copolymer in its tack, adhesion and shear properties.

TABLE 2

| | | Block | Tackifier | Liquid | Desired |
|---|---|---|---|---|---|
| Exam- | Block | Copolymer | resin | plasticizer | Tg |
| ple | Copolymer | (wt %) | (wt %) | (wt %) | (C.) |
| C5 | KD1340 | 50.17 | 45.51 | 4.32 | 258 |
| C8 | KD1340 | 50.17 | 49.32 | 0.51 | 263 |
| C6 | KD1161 | 50.17 | 45.51 | 4.32 | |
| (COMP) | | | | | |
| C9 | KD1340 | 50.17 | 49.83 | — | |
| (COMP) | | | | | |
| C10 | KD1161 | 50.17 | 49.83 | — | |
| (COMP) | | | | | |
| C11 | KD1340 | 50.17 | — | 49.83 | |
| (COMP) | | | | | |
| C12 | KD1161 | 50.17 | — | 49.83 | |
| (COMP) | | | | | |

### Example-2

Pressure sensitive adhesive based on polymodal asymmetric elastomeric block copolymer (C5 and C8) was tested for 180° peel adhesion and static shear strength. For the purpose of comparison as mentioned above, samples based on linear block copolymer (C6) and samples based out of adhesive compositions with either a tackifying resin or liquid polyisoprene being present with asymmetric polymodal block copolymer and linear block copolymer respectively were also tested. Test results are shown in Table-3.

TABLE 3

| | | | 180° Peel | | | |
|---|---|---|---|---|---|---|
| | 180° Peel | 180° Peel | adh | | | |
| | adh (SS) | adh (PP) | (HDPE) | Static Shear | | |
| | Kg/in | Kg/in | Kg/in | Room | | Static Shear 70° C. |
| | (30 min | (30 min | (30 min | Temperature | Static Shear 70° C. | (1 × 1 × 1000 g) |
| Example | dwell) | dwell) | dwell) | (1 × 1 × 1000 g) | (1 × 1 × 1000 g) | Failure Mode |
| C5 | 2.75 | 1.9 | 1.3 | 10000+ | 10000+ | No Failure |
| C8 | 2.66 | 2.24 | 1.22 | 10000+ | 10000+ | No Failure |
| C6 (COMP) | 2.67 | 1.9 | 1.4 | 10000+ | 1931 | Cohesive F |
| C9 (COMP) | 1.91 | 1.88 | 1.03 | 10000+ | 10000+ | No Failure |
| C10 (COMP) | 1.34 | 2.16 | 1.27 | 10000+ | 1792 | Cohesive |
| C11 (COMP) | 0.060 | 0.020 | 0.020 | 785.0 | 161.0 | Adh Failure |
| C12 (COMP) | 0.020 | 0.010 | 0.010 | 333.0 | 12.0 | Adh Failure |

The data in Table-3 shows that the adhesives containing the asymmetric polymodal block copolymer, tackifying resin and the liquid isoprene (Example C5 and C8) have excellent adhesion on different substrates such as stainless steel (SS), polypropylene (PP) and high density polyethylene (HDPE) and enhanced high temperature shear without the effect of electron beam or UV curing.

### Example-3

The tack test and subsequently the debonding graph of certain pressure sensitive adhesives of the present disclosure were studied. Out of these, examples C5, comprising the pressure sensitive adhesive made from asymmetric polymodal block copolymer was compared with samples containing a linear block copolymer C6 (COMP). For comparison purposes samples based on adhesive compositions with only tackifying resin being present and that with asymmetric polymodal block copolymer and linear block copolymer respectively C9 (COMP) and C10 (COMP) were also tested.

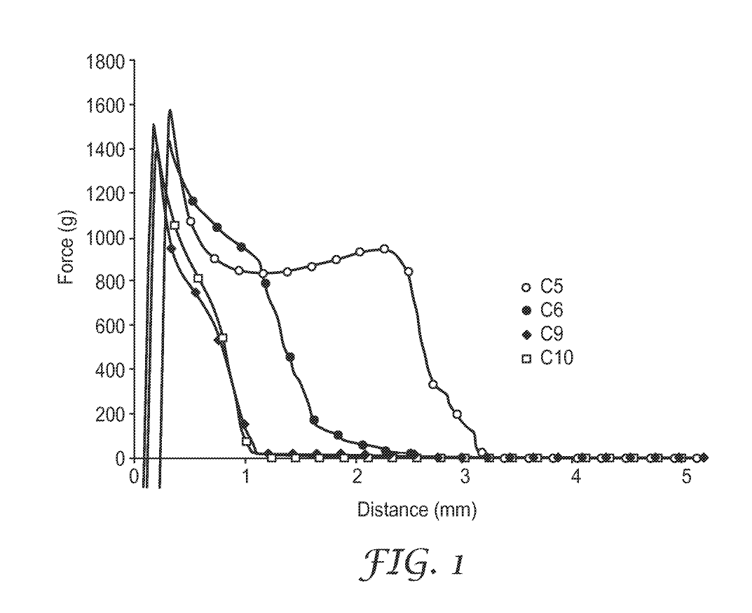

The debonding graph is depicted in FIG. 1 and the results are tabulated in Table-4. Very uniform and good fibrillation was observed with C5 composition which roughly has composition of (Asymmetric block copolymer/tackifier/liquid polyisoprene=100:90:10 as weight ratio). The relative extensibility of pressure sensitive adhesive fibrils with polymodal asymmetric block copolymer (KD 1340) was found higher than corresponding compositions based on linear block polymer (KD 1161). The area under debonding curve is also higher for C5 than for corresponding compositions C6 (COMP). It was further observed that the plateau effect was absent in case of adhesives based on elastomer and only tackifying resin C9 (COMP) and C10 (COMP) irrespective of whether they are made out of asymmetric block copolymer or linear polymer.

TABLE 4

| | Peak | Area under | Distance |
|---|---|---|---|
| | Force | curve | between |
| Example | (g) | (g · mm) | (1:2)* mm |
| C5 | 1582.50 | 2304.82 | 2.933 |
| C8 | 1797.38 | 2237.50 | 3.750 |
| C6 | 1443.89 | 1277.80 | 2.438 |
| (COMP) | | | |
| C9 | 1514.99 | 705.42 | 2.667 |
| (COMP) | | | |
| C10 | 1438.91 | 685.60 | 0.991 |
| (COMP) | | | |

*Point 1 corresponds to start off point in debonding curve of PSAs during tack test and Point 2 is the end point of debonding curve for any particular compositions (X = 0); The distance between 1 and 2 is regarded as maximum elongation of adhesive before debonding at ambient atmosphere temperature and pressure which prevails during tack test.

At peak maxima during debonding of PSA there is initiation of cracks at adhesive interface from substrates. These will be followed by extension of PSA fibrils or the expansion of cavities at interface of adhesive and substrate in both lateral and vertical direction. This is followed by elongation of walls in-between the cavities in the direction of applied stress at an approximately constant level of nominal stress and providing a plateau effect as shown in the curve which is based on KD 1340, followed by fracture by creeping which should be regarded as cohesive failure or debonding of foot of polymer fiber from the probe which corresponds to the maximum elongation of adhesive fibril (point 2) in typical debonding curves as shown below. (The delamination could occur from probe surface also if probe is of lower surface energy materials than SS which is the base platen of equipment and if the adhesive has greater adhesion on SS than second surface of contact).

### Example-4

Various trilayer adhesive systems like (H-H-H), (S-S-S) and (H-S-H) were made by laminating Example C5 and Example C1 which are made out of pressure sensitive adhesive of varying compositions as shown in Table 5. The H layer consists of Example C5 and S layer consist of Example C1.

TABLE 5

| | | Block | Tackifier | Liquid | Desired |
|---|---|---|---|---|---|
| Exam- | Block | Copolymer | resin | plasticizer | Tg |
| ple | Copolymer | (wt %) | (wt %) | (wt %) | (° C.) |
| C1 | KD1340 | 43.71 | 30.71 | 25.58 | 240 |
| C5 | KD1340 | 50.17 | 45.51 | 4.32 | 258 |

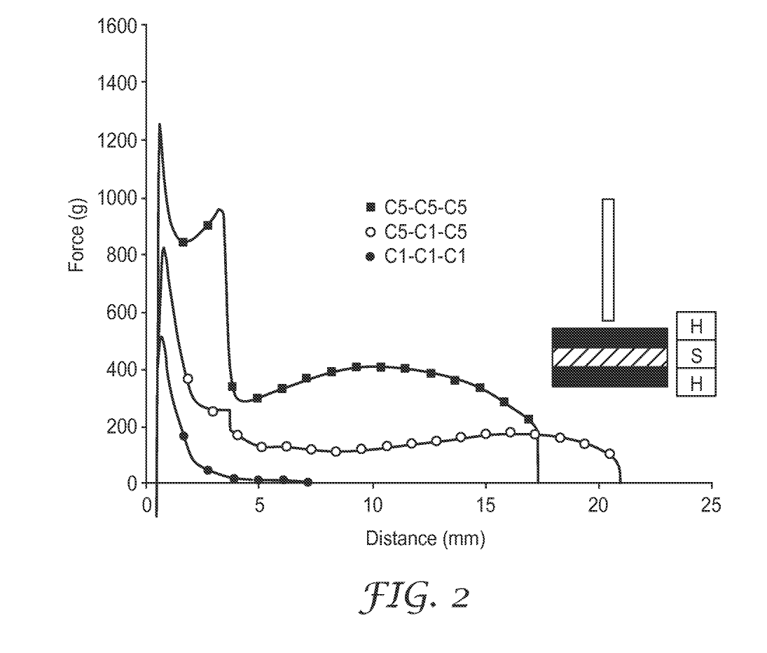

Individual layers were made by lamination by pressing with 4.5 lb.±0.1 lb (2.04 kg) roller which conforms to the Pressure Sensitive Tape Council (PSTC) Specifications. Each trilayer adhesive was kept for 24 hours before tack test. The thickness of individual layers as employed for the below tack test experiments were close to 0.2 mm; and more precisely H layer has average thickness of dry adhesive of 0.214 mm and for S layer the thickness of dried adhesive was 0.217 mm on an average. Tack tests were performed in similar condition as mentioned above. The debonding graph of both single and trilayer pressure sensitive adhesive system are as depicted in FIG. 2 and the summary of the tack test results are tabulated in Table 6. Fibril extension before delamination was observed highest in (H-S-H) composition as shown in FIG. 2 which is higher than corresponding elongation of (H-H-H) and (S-S-S) type of adhesive during debonding test.

TABLE 6

| | | Area under | Distance |
|---|---|---|---|
| | Peak Force | curve | between (1:2) |
| Sample | (g) | (g-mm) | mm |
| C5 | 1582.5 | 2304.821 | 2.933 |
| C1 | 857.557 | 455.43 | 11.049 |
| C1-C1-C1 | 519.816 | 597.48 | 6.806 |
| (S-S-S) trilayer | | | |
| C5-C5-C5 | 1262.262 | 7669.685 | 16.866 |
| (H-H-H) trilayer | | | |
| C5-C1-C5 | 829.082 | 3761.896 | 20.399 |
| (H-S-H) trilayer | | | |

### Example-5

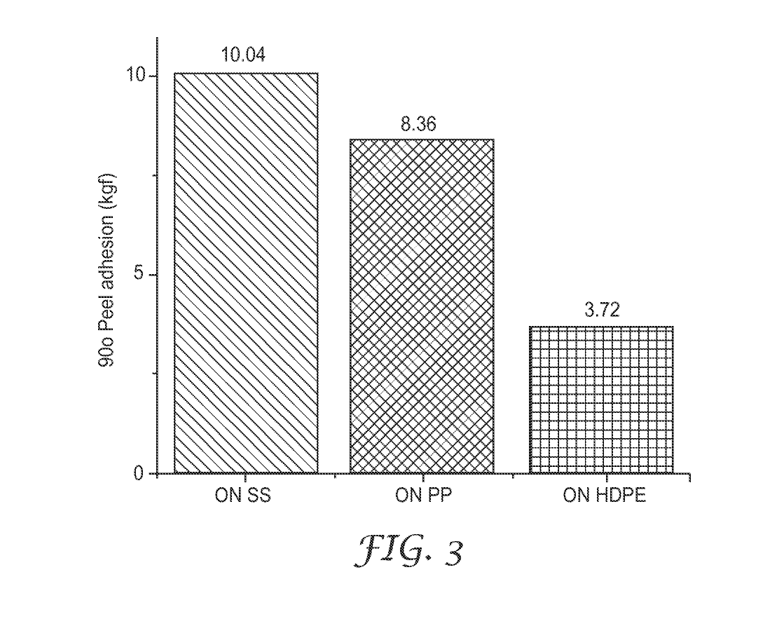

The trilayer system of the type H-S-H corresponding to the pressure sensitive adhesive composition C5-C1-C5 trilayer was studied for 90° peel adhesion on stainless steel (SS), polypropylene (PP) and high density polyethylene (HDPE) panels. The peeling rate was 12 inch/min under experimental conditions of normal room temperature and atmosphere pressure. The results relating the adhesion of trilayer adhesive is as indicated in FIG. 3. This trilayer laminated adhesive composition showed peel value which is greater than 100 oz/inch in low surface energy substrate (LSE) such as HDPE. The backing used in this study was aluminum sheet with approximate thickness of 5 mil. The trilayer adhesive system (C5-C1-C5) was prepared in such a way wherein soft layer C1 was laminated from both sides with hard layer C5 and which faced aluminum on one side and other side of trilayer was adhered on substrate where C5 layer faced adherent substrate.

Thus the pressure sensitive adhesive based on polymodal asymmetric block copolymer described herein above exhibits good adhesion on various substrates such as stainless steel (SS), polypropylene (PP) and high density polyethylene (HDPE) and enhanced high temperature shear without the effect of electron beam or UV curing.

1. A pressure sensitive adhesive comprising:
a) at least 30% by weight of a polymodal asymmetric multiarm elastomeric block copolymer comprising polystyrene and polyisoprene;
b) at least 25% by weight of a tackifying resin; and
c) at least 0.1% by weight of a liquid polyisoprene rubber,
wherein the pressure sensitive adhesive is not crosslinked.

2. The pressure sensitive adhesive of claim 1, wherein the adhesive comprises at least 35% by weight of the polymodal asymmetric multiarm elastomeric block copolymer.

3. The pressure sensitive adhesive of claim 1, wherein the adhesive comprises at least 30% by weight of the tackifying resin.

4. The pressure sensitive adhesive of claim 1, wherein the adhesive comprises at least 5% by weight of the liquid polyisoprene rubber.

5. The pressure sensitive adhesive of claim 1, wherein the polymodal asymmetric multiarm elastomeric block copolymer comprises a polymerized monovinyl aromatic compound and a conjugated diene having the formula QₙY and wherein: Q represents an individual arm of the block copolymer and has the formula S-B; n represents the number of arms Q in the block copolymer and is a whole number of at least 3; and Y is the residue of a multifunctional coupling agent; and further wherein: (a) S is a nonelastomeric polymer segment endblock of a polymerized monovinyl aromatic homopolymer that is polystyrene, there being at least two different molecular weight endblocks in the copolymer, a higher molecular weight endblock and a lower molecular weight endblock, wherein: (i) the number average molecular weight of the higher molecular weight endblock (Mₙ)H is at least 5,000; (ii) the number average molecular weight of the lower molecular weight endblock (Mₙ)L is at least 1,000; and (b) B is an elastomeric polymer segment midblock which connects each arm to the residue of a multifunctional coupling agent (Y) and comprises a polymerized conjugated diene that is polyisoprene and wherein the polymerized monovinyl aromatic compound is present in an amount of at least 4% by weight of the total weight of the block copolymer and the polymerized conjugated diene is present in an amount of at least 60% by weight of the total weight of the block copolymer.

6. The pressure sensitive adhesive of claim 5, wherein the polymerized monovinyl aromatic compound is present in an amount of at least 6% by weight of the total weight of the block copolymer.

7. (canceled)

8. (canceled)

9. The pressure sensitive adhesive of claim 5, wherein the multifunctional coupling agent is selected from the group consisting of o-divinylbenzene, m-divinylbenzene, p-divinylbenzene, and mixtures thereof.

10. The pressure sensitive adhesive of claim 5, wherein the number of arms containing higher molecular weight endblocks is at least 10% of the total arms in the block copolymer.

11. The pressure sensitive adhesive of claim 1, wherein the tackifier resin is selected from rosin and rosin derivatives, polyterpenes, coumarone indenes, hydrogenated resins and hydrocarbon resins.

12. The pressure sensitive adhesive of claim 11, wherein the tackifier resin is a hydrocarbon resin selected from alpha pinene-based resins, beta pinene-based resins, limonene-based resins, piperylene-based hydrocarbon resins, esters of rosins, polyterpene and aromatic modified polyterpene resins, aromatic modified piperylene-based hydrocarbon resins, aromatic modified dicyclopentadiene-based hydrocarbon resins and aromatic modified co-terpene and ter-terpene resins.

13. The pressure sensitive adhesive of claim 12, wherein the tackifying resin is a hydrogenated hydrocarbon resin.

14. A multilayer adhesive system represented by the formula:
-H-S-H-
wherein the layers H and S are referred to as hard and soft layers respectively and wherein the hard layer is derived from a pressure sensitive adhesive comprising: at least 30% by weight of a polymodal asymmetric multiarm elastomeric block copolymer comprising polystyrene and polyisoprene; at least 40% by weight of a tackifying resin; and at least 0.1% by weight of a liquid polyisoprene rubber; and wherein the soft layer is derived from a pressure sensitive adhesive composition comprising: at least 48% by weight of a polymodal asymmetric multiarm elastomeric block copolymer comprising polystyrene and polyisoprene; at least 25% by weight of a tackifying resin; and at least 15% by weight of a liquid polyisoprene rubber, wherein the layers H and S are not crosslinked.

15. An article comprising a backing sheet having first and second surfaces which is coated by a pressure sensitive adhesive on at least a portion of the first surface, wherein the pressure sensitive adhesive comprises:
a) at least 30% by weight of a polymodal asymmetric multiarm elastomeric block copolymer;
b) at least 25% by weight of a tackifying resin; and
c) at least 0.1% by weight of a liquid polyisoprene rubber,
wherein the pressure sensitive adhesive is not crosslinked.

16. The article of claim 15, wherein the backing sheet is a plastic film or paper.
